(19) United States
(12) Patent Application Publication
(10) Pub. No.: US 2008/0290112 A1
(43) Pub. Date: Nov. 27, 2008

(54) Soap dispenser and method for helping assure clean hands

(76) Inventor: John Morris Lynn, Austin, TX (US)

Correspondence Address: HOUSTON OFFICE OF;NOVAK DRUCE AND QUIGG LLP, 1000 LOUISIANA STREET, FIFTY-THIRD FLOOR, HOUSTON, TX, 77002, US

(21) Appl. No.: 12/000,318

(22) Filed: Dec. 11, 2007

Related U.S. Application Data
(60) Provisional application No. 60/874,083, filed on Dec. 11, 2006.

(51) Int. Cl. B67D 5/06; B44B 5/00; G01N 31/22; G01C 15/02

(52) U.S. Cl. 222/23; 101/3.1; 116/200; 116/201

(57) ABSTRACT

A method and apparatus for helping to assure cleaner hands using a soap dispenser are disclosed. The method includes marking a hand of a user with a slight indentation on their hand when they activate the dispenser, wherein the indentation lasts during the desired period of hand washing.

### CROSS REFERENCE TO RELATED APPLICATIONS

This application claims priority from Provisional Application No. 60/874,083 filed on Dec. 11, 2006 and entitled “SOAP DISPENSER AND METHOD FOR HELPING ASSURE CLEAN HANDS,” the disclosure of which is hereby incorporated by reference in its entirety.

### TECHNICAL FIELD

The present disclosure relates in general to the field of maintaining sanitation using a soap dispenser, and, more particularly, to doing so by having the soap dispenser leave an indentation on the user's hand, which indentation lasts roughly the desired period of hand washing.

### BACKGROUND

In a variety of different fields, including businesses and residences, there is a great desire to encourage people to wash their hands more effectively. The U.S. Center for Disease Control has stated that the most important thing people can do to keep from getting sick is to wash their hands. And yet, many people, through lack of knowledge, poor habits or simple negligence do not wash their hands for a long enough period of time. Most professionals and doctors specify that at least 15-20 seconds is required for effective hand washing.

An example of a specific need for helping to assure improved hand washing is the food services industry. It has been known for many decades that food preparers, servers and so forth should clean and sanitize their hands prior to handling food to be served. This need is self-evident when food service employees enter restrooms. Bacteria (such as E-coli, those found in fecal matter, uncooked foods, etc.) in restrooms are well known health hazards and without proper cleaning/sanitization of the hands of restaurant employees, can be transmitted to unknowing customers. These and other concerns also suggest a need for improved hand washing in private residences, especially in homes with children.

Presently there are several systems intended to address the problem of abbreviated hand washing. A liquid hand soap, commercially available as SquidSoap (U.S. Pat. Nos. 6,147,607, 6,031,461 and 6,211,788), helps assure longer hand washing by putting a mark with an easily identifiable substance on a user's hand. The mark does not come off unless the hands are washed well. These systems work well but have the downside that some people don't want to be policed in their hand washing (i.e. SquidSoap leaves a residual mark on their hand if they fail to wash for long enough) and also from time to time the easily identifiable substance (e.g. the ink or vegetable dye) can inadvertently get on clothing or other articles.

Additionally, U.S. Pat. Nos. 5,670,945; 6,426,701; 5,945,910; 5,812,059; 5,202,666; 4,896,144; 3,967,478; 5,771,925; 5,610,589; 4,688,585 and 5,199,188 and U.S. Patent Application Nos. 2003/0030562; 2003/0197122; 2003/0019536; and 2004/0001009 all involve relatively complex systems containing components such as complex electronics, timers, disinfection basins, location sensors, pumps and so forth (often mixed together in complex attempts to require hand washing).

In summary, many of the presently available systems are typically expensive, complex to install, difficult to maintain and it can be difficult to train users in their operation. A simpler system, marking with an easily identifiable substance works well but has the potential downside of sometimes leaving a residual mark or from time to time staining undesired objects.

### SUMMARY

In accordance with the present disclosure, the disadvantages and problems associated with prior products which attempt to assure that hands are washed for long enough have been substantially reduced or eliminated. In a particular embodiment, a hand and/or fingers of a user is temporarily indented by a textured surface on the activating mechanism on the dispenser. For the purpose of this disclosure the term “textured surface” can mean any surface which is not entirely flat or smooth (e.g. having either topography or relief features). Such a “textured surface” when pressed to activate the dispenser may leave a temporary indentation on the user's hand. The texture on the activation surface is designed such when dispensing the soap it leaves a slight indentation on the hand which disappears in roughly the same period of desired hand washing.

### BRIEF DESCRIPTION OF THE DRAWINGS

A more complete and thorough understanding of the present disclosure and advantages thereof may be acquired by referring to the following description taken in conjunction with the accompanying drawings, in which like reference numbers indicate like features, and wherein:

FIG. 1 illustrates a cross-sectional view of one embodiment of an indentation making soap dispenser according to teachings of the present disclosure; and

FIG. 2 illustrates a cross-sectional view of an exemplary embodiment of a commercial, wall mounted soap dispenser according to teachings of the present disclosure.

### DETAILED DESCRIPTION

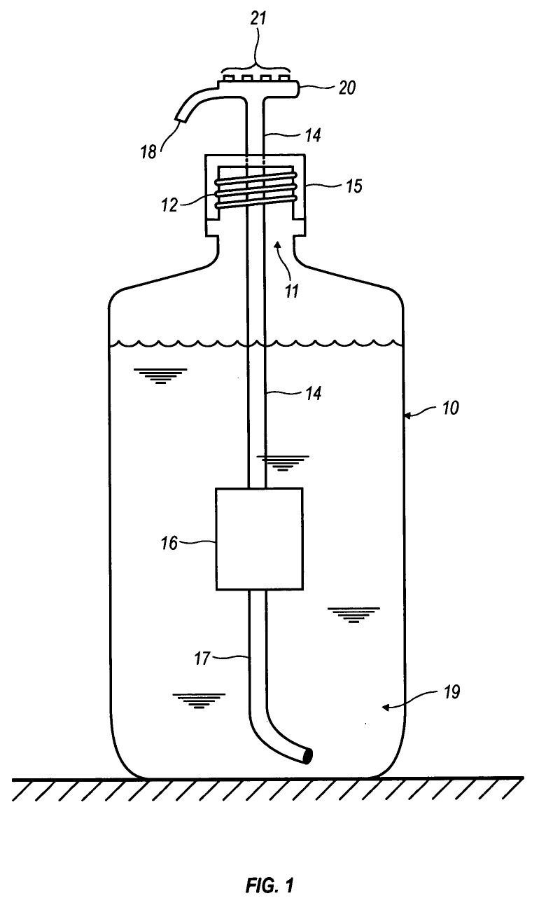

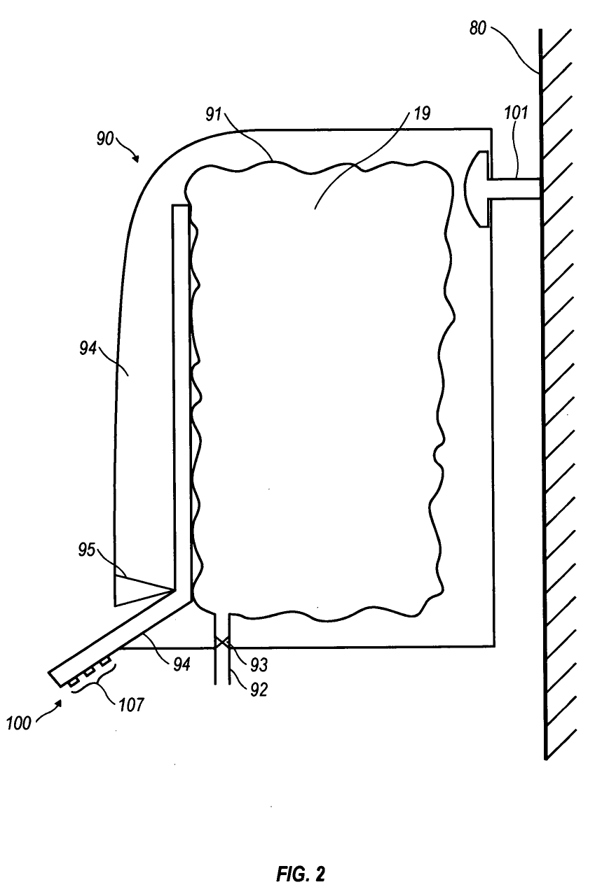

Preferred embodiments of the present disclosure and their advantages are best understood by reference to FIGS. 1 and 2, where like numbers are used to indicate like and corresponding parts.

FIG. 1 is a cross-sectional view of one embodiment of a hand marking soap dispenser. In the embodiment of FIG. 1, the dispenser includes container 10 for cleaning composition 19. Container 10 has opening 11 defined by threaded male lip 12. Male lip 12 is designed to fit female threaded cap 15 so that cap 15 can be taken on and off to allow container 10 to be filled or refilled with cleaning composition 19. In other embodiments, it may also be possible for the dispenser to be designed such that the entire apparatus is disposable after cleaning composition 19 has been depleted. In this embodiment there is no need for cap 15 or cap 15 can be designed such that it will go on but then can not be removable (e.g. in cases where it is preferable that container 10 not be refillable so that a user is required to buy a new dispenser as opposed to simply refilling the dispenser with cleaning composition 19).

Container 10 may be designed to sit substantially flat on a surface such as a table, sink or counter. Container 10 may also be configured (not expressly shown) to mount on a wall or other vertical surface. Additionally, the shape of container 10 may be varied. For use with children, container 10 may be made in the shape of an animal or action hero.

Discharge pipe/outlet/hose 14 may be integral to cap 15 such that pipe 14 extends through opening 11. Additionally, discharge pipe 14 may include orifice 18 where cleaning composition 19 exits the dispenser such that cleaning composition 19 is introduced onto a person's hand. In one embodiment, discharge pipe 14 may be movable up and down through cap 15 and may be coupled to pump mechanism 16, which may have a spring mechanism and plunger such as those used in liquid dispensers well known in the art. In other embodiments, pump mechanism 16 may be any suitable type of pump used to force liquids out of a container. In one embodiment, pump mechanism may be a foaming pump that mixes cleaning composition 19 and air before dispensing cleaning composition 19 through orifice 18. An example of this type of pump is RF-17 Palm Foamer manufactured by Rieke Packaging Systems or foaming pumps by Rexam/Airspray. Pump mechanism 16 may also be coupled to siphon/suction pipe 17. The up and down motion of discharge pipe 14 associated with pump mechanism 16 may cause cleaning composition 19 to be sucked into siphon pipe 17, into pump mechanism 16, through discharge pipe 14 and ultimately out through orifice 18. Discharge pipe 14 includes or is coupled with activation surface 20 which users push on to activate the pump and get the soap. In other embodiments, any other mechanism may be used to dispense cleaning composition 19 from container 10. Fore example, cleaning composition 19 may be dispensed onto a person's hands by using any type of suitable electronics that require an activation mechanism. Using various types of pumps to dispense cleaning compositions is well known in the art. Numerous different types of pumps are included in many different types of commercially available dispensers. Any activation mechanism that requires pressure to activate the soap dispenser can be utilized with the subject invention. Accordingly, various modifications may be made to the exemplary embodiment discussed herein without departing from the spirit of the teachings of the present disclosure.

Similar to existing soap dispensers, the normal unbiased position of discharge pipe 14 and activation surface 20 is up (due to springs or other biasing means inside pump 16). For many traditional hand soap dispensers it requires between approximately three (3) and six (6) pounds (more typically between 4-5 pounds) of pressure on activation surface 20 to overcome the upward bias of the spring's biasing mechanism and to extract cleaning composition 19. (The amount of pressure—and accordingly the characteristics of the indentation on the hand—can be modified by changing the springs or biasing means inside of pump 16.)

With a consistent amount of pressure required to pump the soap out of container 10 it is easy to design various types of “inconsistent surfaces” on activation surface 20 which will cause an indentation on a person's hand and/or fingers which will disappear in the desired time of 15-20 seconds. An unlimited amount of shapes and sizes of features on activation surface 20 will work and may cause the desired indentation in the user's hand.

One embodiment of a textured or irregular surface as shown in the cross section of FIG. 1 includes raised areas 21. As a user presses on activation surface 20 to dispense soap 19, the raised areas 21 will cause a shallow indentation in the user's hand or fingers since the pressure required to activate pump 16 presses raised areas 21 into the skin of the user.

In an example using the commercially available SquidSoap dispenser, the normal ink marking mechanism was removed and instead two concentric raised circles were attached to the top of the pump. These concentric circles were both 1 mm in cross section (i.e. 1 mm high and 1 mm in width). The interior circle was 13 mm in diameter and the outside circle was 18 mm in diameter.

With the pressure required to active the SquidSoap pump to dispense the soap, it was determined that these raised circles resulted in a slight indentation in a user's hand that typically disappeared in roughly 15-20 seconds. These raised circles had a combined raised area of about 97.34 square millimeters (i.e. pi times 13 mm+pi times 18 mm). In this experiment it was determined that this configuration was not uncomfortable for a user. Improved comfort for a user can be accomplished by things such as maximizing to the extent possible the surface areas of the raised areas and also by rounding off or smoothing out edges.

The example given immediately above is one of an unlimited number of textured or irregular surfaces that would work to make an indentation that typically would disappear in the amount of time desired for hand washing. Rather than the textured part of the activation surface being raised the textured part of activation surface could instead be comprised of recessed areas (i.e. areas lower than the flat part of the activation surface). In a separate embodiment it could include a combination of raised and recessed areas. The textured or irregular surface could be any size and any shape so long as it puts an indentation in a user's hand which fades away during the desired hand washing duration.

Focusing on the size and shape of the raised or recessed areas is one way to assure that the desired indentation is obtained. This focus on the surface area of the textured surface can work to give one the desired indentation on a user's hand without regard to the height or depth of the textured surface. However, an alternative way to get a desired indentation on a user's hand is to focus less on the size or shape of the textured areas and focus instead on the height of the raised areas or depth of the recessed areas. In this embodiment, the user's skin is indented to the full height or depth of the textured area and this can be designed to give an indentation which lasts at least 10 seconds, but more preferably the desired 15-20 seconds. In a preferred embodiment, both the size and shape of the texture and height and/or depth of the textured surface are both controlled for optimal skin indentation.

In another embodiment, the activation surface may not include a textured or irregular surface but instead may be sized so that even if the surface is relatively flat or smooth the surface area is small enough that the entire activation surface makes the desired indentation on the user's hand.

In yet a further embodiment, the pressure required to trigger the activation means may be designed to be variable so that indentations of varying depths on the user's hand may be obtained. This can be accomplished by incorporating biasing means (e.g. springs) that can be tightened or loosened to make if either harder or easier to dispense the soap out of the dispenser. In this embodiment, users are able to fine tune the indentation to their own comfort level or to increase or decrease the amount of time the indentation lasts on their skin.

FIG. 2 is a cross-sectional view of one embodiment of a commercial, wall-mounted soap dispenser that includes a marking mechanism. In the illustrated embodiment, the soap dispenser includes cover 90 coupled to wall 80 using attachment mechanism 101. Attachment mechanism 101 may be a bolt, screw, nail, hook, pin, rivet, lug, latch, clamp or any other suitable type of fastener that allows the dispenser to be mounted on wall 80. In other embodiments, attachment mechanism 101 may be double-sided tape, a pressure sensitive adhesive (PSA), non-permanent adhesive glues and/or gels, a Velcro®-like material and any other attachment mechanisms that allow for the dispenser to be detachably mounted on wall 80. The soap dispenser further includes container 91 located within cover 90 that contains cleaning composition 19.

Container 91 may be an elastomer bag, thermoplastic bottle or any other container that is capable of sustaining deformation under a pressure (e.g., a pressure exerted when lever 94 is pushed toward container 91 by a user of the dispenser) without permanent loss of size or shape. Effluent channel 92 including valve 93 may be located at the bottom of container 91. In one embodiment, valve 93 may prevent cleaning composition 19 from draining out of container 91 through effluent channel 92 due to gravity when container 91 is not being compressed. The use of compressible containers, effluent channels and valves in commercial dispensers are known in the art and as such various modifications may be made to the exemplary embodiment discussed herein without departing from the spirit of the teachings of the present disclosure.

The soap dispenser may further include lever 94 that may be pushed inward or pulled outward by a user's hand when the user pushes or pulls on activation surface 100. This activation motion causes lever 94 to rotate (e.g., in a clockwise direction, as shown in FIG. 2) around pivot point 95 that is attached to cover 90. The motion of lever 94 may exert pressure on container 91 such that cleaning composition 19 is dispensed through effluent channel 92.

Similar to the embodiment described in FIG. 1, activation surface 100 has raised areas 107 which are intended to put a small indentation on the user's hand when they exert enough pressure on lever 94 to dispense the soap out of container 91. If more pressure is needed for putting effective indentations on a user's hand, it is possible that springs or other biasing means (not expressly shown) may be added so that more pressure is required to dispense the soap when activation surface 100 is contacted.

Although specific mechanisms for dispensing cleaning composition 19 have been described, there are many ways of dispensing cleaning composition 19. These mechanisms may include: motors, pumps, sprayers, printers, valves, compressors, jets, fans, and any combinations thereof. Essentially any method of dispensing liquid cleansers or soap would be covered by this disclosure so long as there is an activation surface that requires sufficient pressure to activate and make an indentation on the person's hand. In cases where not much pressure is typically required to activate the dispenser, additional pressure may be generated by including biasing means (e.g. springs) to make the activation pressure high enough to accomplish the desired indentation on the user's hand. The use of dispensing mechanisms in commercial dispensers are known in the art and as such various modifications may be made to the exemplary embodiment discussed herein without departing from the spirit of the teachings of the present disclosure.

Although the present disclosure has been described in detail, it should be understood that various changes, substitutions, and alterations can be made without departing from the spirit and scope of the disclosure as defined by the appended claims.

What is claimed is:

1. A cleaning composition dispenser, comprising:
a reservoir sized to receive an amount of cleaning composition; and
an activation mechanism by means of which cleaning composition is dispensed from the reservoir;
wherein the activation mechanism includes means for making a temporary indentation on a user's skin that lasts for at least about 10 seconds.

2. The cleaning composition dispenser of claim 1, wherein the activation mechanism is a mechanical dispenser.

3. The cleaning composition dispenser of claim 1, wherein the activation mechanism is an electrical dispenser.

4. The cleaning composition dispenser of claim 1, wherein the means for making a temporary indentation includes at least one raised surface.

5. The cleaning composition dispenser of claim 1, wherein the means for making a temporary indentation includes at least one recessed surface.

6. The cleaning composition dispenser of claim 1, wherein the activation mechanism is adapted to be pulled or depressed in order to dispense the cleaning composition.

7. The cleaning composition dispenser of claim 6, wherein the activation mechanism is comprised of a means to resist pulling or depressing.

8. The cleaning composition dispenser of claim 6, wherein the force required to pull or depress the activation mechanism is adjustable.

9. The cleaning composition dispenser of claim 6, wherein the force required to pull or depress the activation mechanism is at least 3 pounds.

10. A cleaning composition dispenser, comprising:
a reservoir sized to receive an amount of cleaning composition; and
an activation mechanism by means of which cleaning composition is dispensed from the reservoir;
wherein the activation mechanism includes a textured or irregular surface for making a temporary indentation on a user's skin that lasts for at least about 10 seconds.

11. The cleaning composition dispenser of claim 10, wherein the activation mechanism is a mechanical dispenser.

12. The cleaning composition dispenser of claim 10, wherein the activation mechanism is an electrical dispenser.

13. The cleaning composition dispenser of claim 10, wherein the textured or irregular surface includes at least one raised surface.

14. The cleaning composition dispenser of claim 10, wherein the textured or irregular surface includes at least one recessed surface.

15. The cleaning composition dispenser of claim 10, wherein the activation mechanism is adapted to be pulled or depressed in order to dispense the cleaning composition.

16. The cleaning composition dispenser of claim 15, wherein the activation mechanism includes a means to resist pulling or depressing.

17. The cleaning composition dispenser of claim 15, wherein the force required to pull or depress the activation mechanism is adjustable.

18. The cleaning composition dispenser of claim 15, wherein the force required to pull or depress the activation mechanism is at least 3 pounds.

19. A method to assist in monitoring the time one takes to wash his/her hands, the method comprising the steps of:
activating a cleaning composition dispenser by means of an activation mechanism to dispense an amount of cleaning composition from the dispenser; and
making a temporary indentation in one's skin that lasts at least about 10 seconds, wherein the temporary indention is made by the activation mechanism upon activation thereof.

20. The method of claim 19, further comprising washing one's hands until the temporary indentation disappears.

21. The method of claim 19, further comprising removing any remaining cleaning composition left on one's hands.

22. The method of claim 27, wherein the step of removing any remaining cleaning composition left on the hands is accomplished with water.

23. The method of claim 19, wherein the force used to activate the dispensing mechanism is at least 3 pounds of force.
